(19) United States
(12) Patent Application Publication
(10) Pub. No.: US 2014/0003312 A1
(43) Pub. Date: Jan. 2, 2014

(54) WAKE-UP FUNCTIONALITY FOR AN LTE ENODEB

(71) Applicants: Vadim Sergeyev, Nizhny Novgorod (RU); Alexei Davydov, Nizhny Novgorod (RU); Gregory Morozov, Nizhny Novgorod (RU); Alexander Maltsev, Nizhny Novgorod (RU); Jong-Kae Fwu, Sunnyvale, CA (US); Youn Hyoung Heo, Seoul (KR)

(72) Inventors: Vadim Sergeyev, Nizhny Novgorod (RU); Alexei Davydov, Nizhny Novgorod (RU); Gregory Morozov, Nizhny Novgorod (RU); Alexander Maltsev, Nizhny Novgorod (RU); Jong-Kae Fwu, Sunnyvale, CA (US); Youn Hyoung Heo, Seoul (KR)

(21) Appl. No.: 13/672,548

(22) Filed: Nov. 8, 2012

Related U.S. Application Data
(60) Provisional application No. 61/667,325, filed on Jul. 2, 2012.

(51) Int. Cl. H04W 52/02

(52) U.S. Cl. CPC H04W 52/0206
USPC 370/311

(57) ABSTRACT

Embodiments of the present disclosure include methods and apparatuses, for a third generation partnership project (3GPP) enhanced NodeB (eNB) to transmit parameters of a wake-up procedure with a 3GPP user equipment (UE). After the transmission, the eNB may enter a low power state wherein it monitors for the wake-up signal from the UE, the wake-up signal being based at least in part on the transmitted parameters of the wake-up procedure. When the eNB receives the wake-up signal, the eNB may enter the high-power state and transmit a connection establishment signal to the UE.

### CROSS REFERENCE TO RELATED APPLICATIONS

The present application claims priority to U.S. Provisional Patent Application No. 61/667,325, filed Jul. 2, 2012, entitled “Advanced Wireless Communication Systems and Techniques,” the entire disclosure of which is hereby incorporated by reference in its entirety.

### FIELD

Embodiments relate to systems, methods and instructions for a third generation partnership project (3GPP) eNodeB (eNB) to enter, and return from, a low-power sleep mode upon reception of a wake-up signal from a 3GPP user equipment (UE).

### BACKGROUND

The background description provided herein is for the purpose of generally presenting the context of the disclosure. Work of the presently named inventors, to the extent it is described in this background section, as well as aspects of the description that may not otherwise qualify as prior art at the time of filing, are neither expressly nor impliedly admitted as prior art against the present disclosure. Unless otherwise indicated herein, the approaches described in this section are not prior art to the claims in the present disclosure and are not admitted to be prior art by inclusion in this section.

Conventional eNBs typically serve a large number of users over a large coverage area. However, as 3GPP long term evolution (LTE) network technology develops, eNBs are being considered for reduced coverage areas, for example a single home or office. When the coverage area for the eNB is reduced, there may be significant periods where there is no user traffic on the eNB. However, the eNB may remain powered up during these times, thereby un-necessarily wasting power.

### BRIEF DESCRIPTION OF THE DRAWINGS

Embodiments will be readily understood by the following detailed description in conjunction with the accompanying drawings. To facilitate this description, like reference numerals designate like structural elements. Embodiments are illustrated by way of example and not by way of limitation in the figures of the accompanying drawings.

FIG. 1 schematically illustrates a high-level example of a network system comprising a UE and an eNB, in accordance with various embodiments.

FIG. 2-A illustrates an exemplary flowchart of an eNB entering a low-power mode, in accordance with various embodiments.

FIG. 2-B illustrates an exemplary flowchart of an eNB exiting a low-power mode, in accordance with various embodiments.

FIG. 3-A illustrates an exemplary wake-up signal configuration, in accordance with various embodiments.

FIG. 3-B illustrates another exemplary wake-up signal configuration, in accordance with various embodiments.

FIG. 3-C illustrates another exemplary wake-up signal configuration, in accordance with various embodiments.

FIG. 3-D illustrates another exemplary wake-up signal configuration, in accordance with various embodiments.

FIG. 4 schematically illustrates an example system that may be used to practice various embodiments described herein.

### DETAILED DESCRIPTION

Apparatuses and methods are described herein for allowing an eNB to enter a sleep mode where one or both of transmission and reception functions may be powered down for a period of time. Before entering the sleep mode, the eNB may transmit parameters of a wake-up procedure with the UEs with which it is in communication. The parameters may include a code sequence and/or timing information which can be used by the UE to construct a wake-up signal. When the UE needs to communicate with the eNB, the UE may transmit the wake-up signal and cause the eNB to return from sleep mode.

In the following detailed description, reference is made to the accompanying drawings which form a part hereof wherein like numerals designate like parts throughout, and in which is shown by way of illustration embodiments that may be practiced. It is to be understood that other embodiments may be utilized and structural or logical changes may be made without departing from the scope of the present disclosure. Therefore, the following detailed description is not to be taken in a limiting sense, and the scope of embodiments is defined by the appended claims and their equivalents.

Various operations may be described as multiple discrete actions or operations in turn, in a manner that is most helpful in understanding the claimed subject matter. However, the order of description should not be construed as to imply that these operations are necessarily order dependent. In particular, these operations may not be performed in the order of presentation. Operations described may be performed in a different order than the described embodiment. Various additional operations may be performed and/or described operations may be omitted in additional embodiments.

For the purposes of the present disclosure, the phrases “A and/or B” and “A or B” mean (A), (B), or (A and B). For the purposes of the present disclosure, the phrase “A, B, and/or C” means (A), (B), (C), (A and B), (A and C), (B and C), or (A, B and C).

The description may use the phrases “in an embodiment,” or “in embodiments,” which may each refer to one or more of the same or different embodiments. Furthermore, the terms “comprising,” “including,” “having,” and the like, as used with respect to embodiments of the present disclosure, are synonymous.

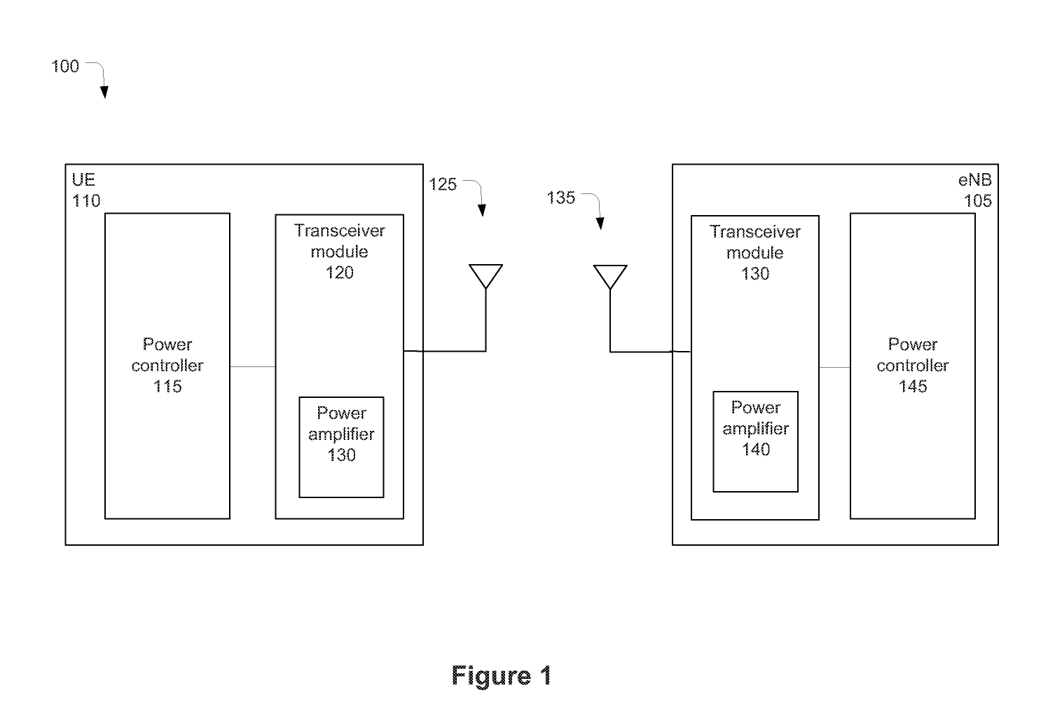

FIG. 1 schematically illustrates a wireless communication network 100 in accordance with various embodiments. Wireless communication network 100 (hereinafter “network 100”) may be an access network of a 3GPP LTE network such as evolved universal terrestrial radio access network (“E-UTRAN”). The network 100 may include an eNB 105, configured to wirelessly communicate with a UE 110. In some embodiments, the eNB 105 may be an LTE hotspot or LTE hotspot indoor (“LTE-Hi”) eNB. In some embodiments, the eNB 105 may be considered a low-power or reduced-range eNB such as, but not limited to, a home eNB.

As shown in FIG. 1, the UE 110 may include a transceiver module 120. The transceiver module 120 may be further coupled with an antenna 125 of the UE 110 for communicating wirelessly with other components of the network 100, e.g., eNB 105. The antenna 125 may be powered by a power amplifier 130 which may be a component of the transceiver module 120, as shown in FIG. 1, or may be a separate component of the UE 110. In one embodiment, the power amplifier 130 provides the power for all transmissions on the antenna 125. In other embodiments, there may be multiple power amplifiers or multiple antennas, or both on the UE 110. The transceiver module 120 of the UE 110 may comprise circuitry for one or both of a transmission function and a reception function. In certain embodiments the transceiver module 120 may be replaced by a separate transmission module containing transmission circuitry and/or a receiver module containing reception circuitry (not shown).

Similarly, the eNB 105 may include a transceiver module 130 coupled with an antenna 135 of the eNB 105 for communicating wirelessly with a network component such as the UE 110. The eNB 105 may further include a power amplifier 140 coupled with the transceiver module 130 and a power control 145. In one embodiment, the power amplifier 140 provides the power for all transmissions on the antenna 135. In other embodiments, there may be multiple power amplifiers or multiple antennas, or both on the eNB 105. Similarly to the UE 110, the transceiver module 130 of the eNB 105 may comprise circuitry for performing one or both of a transmission function and a reception function. In certain embodiments the transceiver module 130 of the eNB 105 may be replaced by a separate transmission module containing transmission circuitry and/or a receiver module containing reception circuitry (not shown).

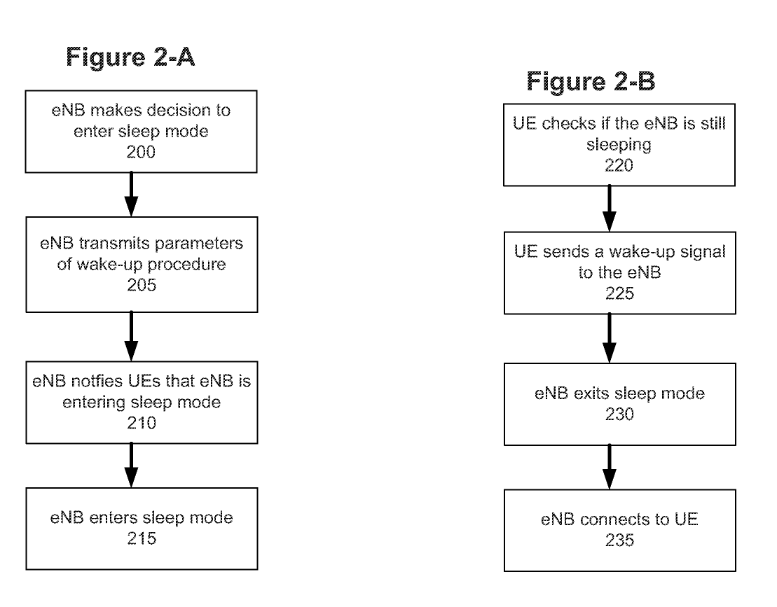

FIG. 2-A shows logic for an eNB such as eNB 105 to enter a low-power sleep mode from a high-powered state in accordance with an embodiment. The term “sleep mode” will be used throughout the remainder of this disclosure, and it will be understood that the term sleep mode refers to a low-power state where one or more of the functions of the corresponding high-powered state may be reduced or eliminated. The high-power state may refer to a state where the one or more functions are powered or used. The term “sleep mode” as used herein is not strictly limited to a “sleep mode” as defined in any 3GPP specification, institute of electrical and electronics engineers (IEEE) specification, or any other specification.

The sleep mode may be entered or controlled through a power controller or processor of the eNB 105, for example power control 145. In some embodiments, both the transmission capabilities and the reception capabilities of the eNB are turned off when the eNB is in sleep mode. In other embodiments, only one of the transmission or the reception capabilities of the eNB may be turned off.

First, the eNB may decide to enter sleep mode at 200. This decision may be in response to inactivity of the eNB for a given period, a specific time of day, information on applications running on one or more UEs such as UE 110 associated with the eNB, traffic received from the 3GPP network, or some other reason.

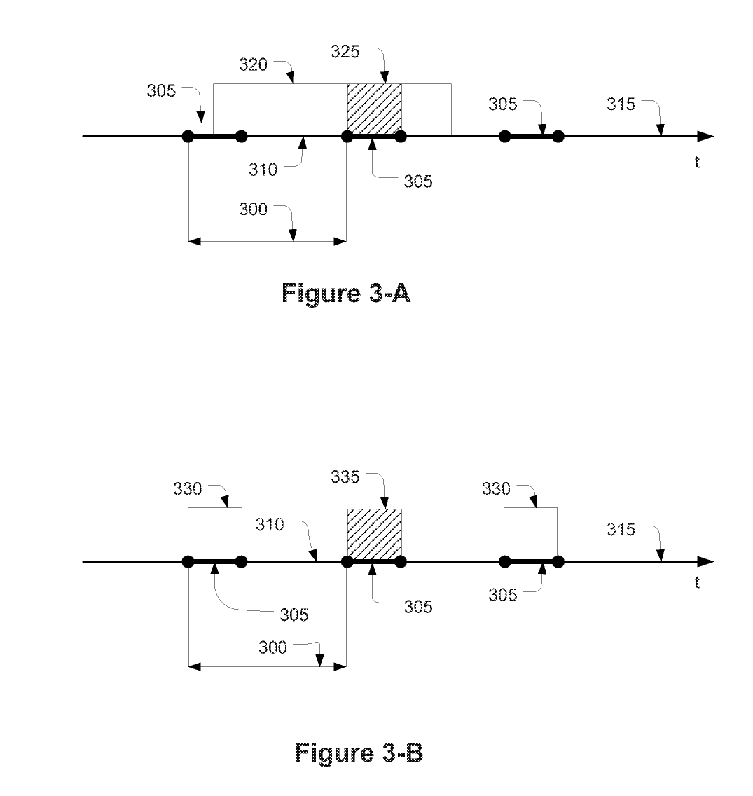

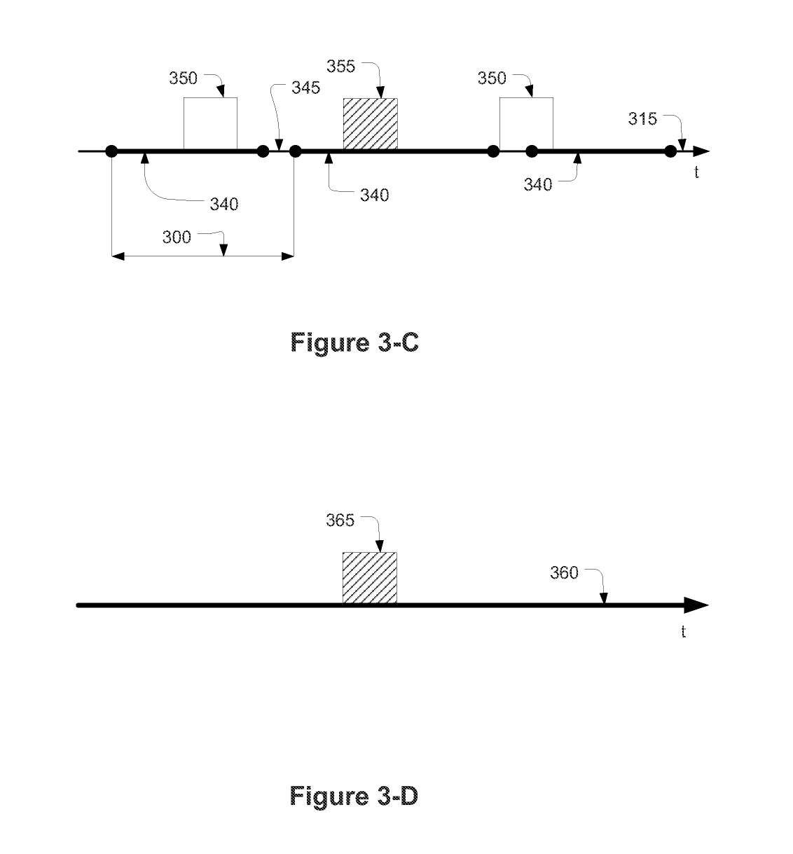

After the eNB decides to enter sleep mode at 200, the eNB may transmit parameters of a wake-up procedure with the UE at 205. In some embodiments the UE may respond and a negotiation process between the eNB and the UE may occur. In certain embodiments the parameters of the wake-up procedure may be transmitted substantially simultaneously or sequentially to the UE. The transmitted wake-up parameters may include information related to the period and duration of time intervals when the eNB is going to turn on its receiver and listen for a wake-up signal to be transmitted from the UE. These intervals may include one or more of the eNB listening period or the eNB listening intervals, which will be discussed below with reference to FIG. 3. The transmitted parameters may also include a digital sequence or code for the wake-up signal that allows the eNB to recognize and distinguish the wake-up signal from ambient radio transmissions or transmissions from UEs on other cells. In some embodiments, the transmitted parameters may reuse parameters that were previously known to both the eNB and the UE. For example, the listening intervals may correspond to random access channel resources configured by the eNB for the UE. Alternatively, the eNB may configure its sleep mode using conventional procedures such as those defined for UE discontinuous reception (DRX). If the eNB is communicating with multiple UEs, one or more of the parameters may be shared between the different UEs, or the parameters maybe unique to each UE so the eNB can differentiate between the UEs.

After the eNB transmits the parameters at 205, the eNB may notify any UEs that are in communication with the eNB that the eNB is going to enter sleep mode at 210. The eNB may notify the UEs so the UEs will not search for synchronization signals from the eNB if the eNB is not going to remain synchronized with the UE. The notification may offer the additional benefit of allowing the UE to determine that it will not receive any messages from the eNB because the eNB is in sleep mode, so the UE may itself enter sleep mode, for example through conventional DRX procedures or other sleep procedures.

After notifying any connected UEs at 210, the eNB may then enter sleep mode at 215. As discussed above, the sleep mode may include one or both of the eNB powering down its receiving functions and transmission functions. In some embodiments, the eNB and the UE may remain synchronized, for example through the use of periodic 3GPP synchronization signals, GPS synchronization signals, or some other synchronization signal. In other embodiments, the eNB and the UE may not remain synchronized. In some embodiments, the eNB may not power down its receiving functions when it is in sleep mode.

FIG. 2-B depicts logic for the eNB exiting sleep mode in accordance with an embodiment. According to this embodiment, a UE that wishes to wake up the eNB may first check to determine whether the eNB is still sleeping at 220. The UE may perform this check at the command of a user, for example if a user wants to make a call or obtain an Internet connection, or based on some other criteria. If the UE determines, as a result of the check at 220, that the eNB is sleeping, then the UE may send a wake-up signal to the eNB at 225. In sending the wake-up signal, the UE may use one or more of the parameters transmitted by the eNB before the eNB entered sleep mode at 205. In some embodiments, the wake-up signal may be sent on a random access channel (RACH). In other embodiments, the wake-up signal may be sent on another channel.

Upon reception of the wake-up signal, the eNB may then exit sleep mode, i.e., wake up, at 230. Waking up may generally include returning to the high-power mode of the eNB, and may specifically include one or both of resuming transmission or reception functionality. The eNB may then perform conventional connection procedures to connect to the UE at 235. In some embodiments the connection procedures may be initiated by the eNB. In other embodiments, the connection procedures may be initiated by the UE. In either embodiment, the eNB may transmit one or more connection establishment signals, for example to initiate the connection procedure or responsive to a signal from the UE.

In some embodiments, the eNB may confirm the identity of the UE sending the wake-up signal. This confirmation may occur before the eNB fully exits sleep mode, or after exiting sleep mode and before further connection procedures occur.

Although the above described procedure is related to an embodiment where the UE sends a wake-up signal to wake-up the eNB, in other embodiments the eNB may exit sleep mode due to another criteria. For example, the eNB may exit sleep mode based on the time of day, information on applications associated with the eNB, traffic received from the 3GPP network, or some other reason.

FIGS. 3-A through 3-D depict negotiated parameters of various embodiments. FIG. 3-A depicts an embodiment where the negotiated parameters may include a listening interval 300 comprising a listening period 305 and a non-listening period 310. The listening interval may be repeated on the time axis 315. In this embodiment, the UE and the eNB may not retain synchronization with one another, so the listening interval 300 may be repeated on the time axis 315, as indicated by the multiple depictions of the listening period 305. Because the eNB and the UE are not synchronized with one another, the UE may transmit a wake-up signal 320 that is at least as long as one listening interval 300. The wake-up signal 320 may include the pre-negotiated digital sequence or code. Because the wake-up signal 320 is at least as long as one listening interval 300, then it is likely that the wake-up signal will coincide 325 with at least one listening period. In some embodiments, it may be preferable to make the wake-up signal 320 at least as long as a listening interval 300 plus an additional listening period 305 to ensure that the wake-up signal 320 will coincide with at least one listening period 305.

FIG. 3-B shows another embodiment where the wake-up signal 330 may be substantially the same length as the listening period 305. In this embodiment, the wake-up signal may then coincide 335 with at least one of the listening period 305. This embodiment may be preferable in situations where the eNB and the UE remain synchronized with one another, for example through the use of GPS synchronization or some other form of synchronization signal.

FIG. 3-C shows another embodiment where the listening period 340 may occupy almost the entire listening interval 300, with only relatively short non-listening periods 345. In this embodiment, because the listening periods 340 are relatively long, the wake-up signal 350 transmission may be relatively short. If the wake-up signal 350 is transmitted a plurality of times, it may be highly statistically likely that the wake-up signal 350 will coincide 355 with at least one listening period 340, however some embodiments may only need to transmit the wake-up signal 350 in a relatively short series.

FIG. 3-D depicts an embodiment where the eNB does not turn off its reception capability. In this embodiment, the listening period and listening interval may be considered to be a single relatively large listening interval 360. In this embodiment, the UE may only need to transmit a single wake-up signal 365. This embodiment may be appropriate for situations where the eNB and the UE are synchronized or situations where the eNB and the UE are not synchronized. Additionally, the wake-up signal may be relatively short and only comprise two orthogonal frequency division multiplexing (OFDM) symbols.

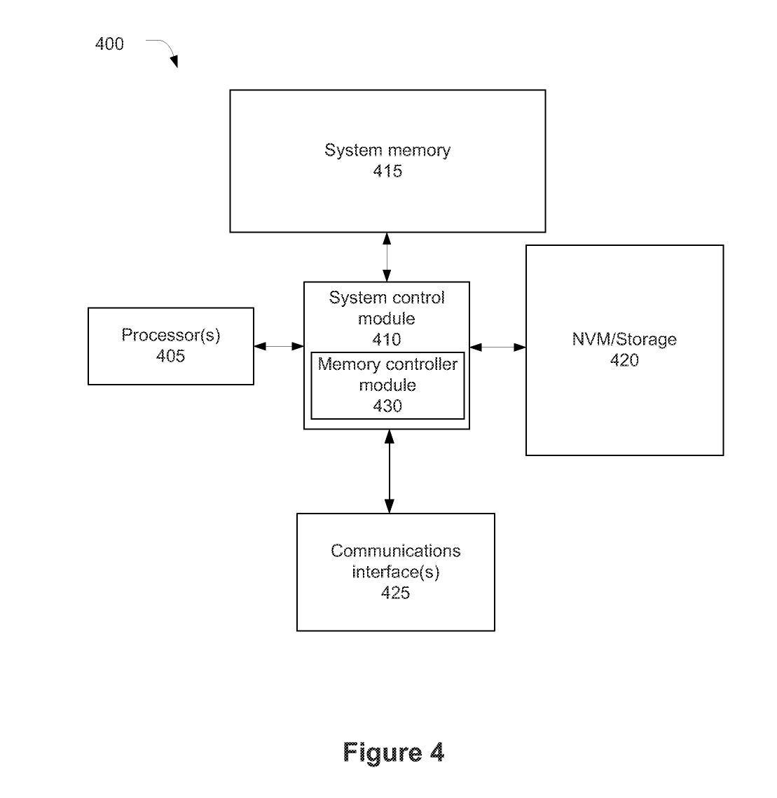

Embodiments of the present disclosure may be implemented into a system using any suitable hardware and/or software to configure as desired. FIG. 4 schematically illustrates an example system 400 that may be used to practice various embodiments described herein. FIG. 4 illustrates, for one embodiment, an example system 400 having one or more processor(s) 405, system control module 410 coupled to at least one of the processor(s) 405, system memory 415 coupled to system control module 410, non-volatile memory (NVM)/storage 420 coupled to system control module 410, and one or more communications interface(s) 425 coupled to system control module 410.

In some embodiments, the system 400 may be capable of functioning as the UE 110 as described herein. In other embodiments, the system 400 may be capable of functioning as the eNB 105 depicted in the embodiment shown in FIG. 1 or any one of the other described embodiments. In some embodiments, the system 400 may include one or more computer-readable media (e.g., system memory or NVM/storage 420) having instructions and one or more processors (e.g., processor(s) 405) coupled with the one or more computer-readable media and configured to execute the instructions to implement a module to perform actions described herein.

System control module 410 for one embodiment may include any suitable interface controllers to provide for any suitable interface to at least one of the processor(s) 405 and/or to any suitable device or component in communication with system control module 410.

System control module 410 may include memory controller module 430 to provide an interface to system memory 415. The memory controller module 430 may be a hardware module, a software module, and/or a firmware module.

System memory 415 may be used to load and store data and/or instructions, for example, for system 400. System memory 415 for one embodiment may include any suitable volatile memory, such as suitable DRAM, for example. In some embodiments, the system memory 415 may include double data rate type four synchronous dynamic random-access memory (DDR4 SDRAM).

System control module 410 for one embodiment may include one or more input/output (I/O) controller(s) to provide an interface to NVM/storage 420 and communications interface(s) 425.

The NVM/storage 420 may be used to store data and/or instructions, for example. NVM/storage 420 may include any suitable non-volatile memory, such as flash memory, for example, and/or may include any suitable non-volatile storage device(s), such as one or more hard disk drive(s) (HDD(s)), one or more compact disc (CD) drive(s), and/or one or more digital versatile disc (DVD) drive(s), for example.

The NVM/storage 420 may include a storage resource physically part of a device on which the system 400 is installed or it may be accessible by, but not necessarily a part of, the device. For example, the NVM/storage 420 may be accessed over a network via the communications interface(s) 425.

Communications interface(s) 425 may provide an interface for system 400 to communicate over one or more network(s) and/or with any other suitable device. The system 400 may wirelessly communicate with the one or more components of the wireless network in accordance with any of one or more wireless network standards and/or protocols.

For one embodiment, at least one of the processor(s) 405 may be packaged together with logic for one or more controller(s) of system control module 410, e.g., memory controller module 430. For one embodiment, at least one of the processor(s) 405 may be packaged together with logic for one or more controllers of system control module 410 to form a System in Package (SiP). For one embodiment, at least one of the processor(s) 405 may be integrated on the same die with logic for one or more controller(s) of system control module 410. For one embodiment, at least one of the processor(s) 405 may be integrated on the same die with logic for one or more controller(s) of system control module 410 to form a System on Chip (SoC).

In various embodiments, the system 400 may be, but is not limited to, a server, a workstation, a desktop computing device, or a mobile computing device (e.g., a laptop computing device, a handheld computing device, a tablet, a netbook, etc.). In various embodiments, the system 400 may have more or less components, and/or different architectures. For example, in some embodiments, the system 400 includes one or more of a camera, a keyboard, liquid crystal display (LCD) screen (including touch screen displays), non-volatile memory port, multiple antennas, graphics chip, application-specific integrated circuit (ASIC), and speakers.

Embodiments provide for methods and apparatuses for reducing power consumption in an eNB in a wireless network. In certain embodiments, the eNB may transmit one or more parameters of a wake-up procedure to a UE, enter a low power state from a high power state, and monitor for reception of a wake-up signal based at least in part on the one or more parameters. Upon receiving the wake-up signal, the eNB may enter a high power state and transmit a connection establishment signal to the UE. In certain embodiments the signal may be received by the eNB on a RACH. In some embodiments the eNB may be configured to continuously monitor for the wake-up signal, and the wake-up signal may have a length of two OFDM symbols.

In some embodiments, the parameters of the wake-up procedure may include a digital sequence to be used for the wake-up signal, and a length of a listening interval. The listening interval may comprise at least one listening period with a listening length, and at least one non-listening period. The parameters of the wake-up procedure may also include the timing of the listening period. In certain embodiments the length of the wake-up signal may be at least the listening length. In other embodiments the length of the wake-up signal may be at least the length of the listening interval. In alternative embodiments the length of the wake-up signal may be less than the listening length.

Alternative embodiments may include a UE comprising receiver circuitry configured to receive the one or more parameters of the wake-up procedure, processing circuitry configured to determine that the UE should connect to an eNB, and transmission circuitry configured to transmit a wake-up signal based at least in part on the one or more parameters to the eNB responsive to the determination. The wake-up signal may be configured to cause the eNB to enter a high power state from a low power state. The receiver circuitry may be further configured to receive a transmission related to a connection establishment procedure.

Other embodiments may include a HeNB comprising a transmitter configured to transmit the one or more parameters of the wake-up procedure to a UE and a receiver configured to receive a wake-up signal based at least in part on the one or more parameters. The HeNB may further comprise a power controller configured to enter a low power mode after transmitting the parameters, and further configured to enter a high power mode upon reception of the wake-up signal. The HeNB may be further configured to transmit a connection establishment signal to the UE upon entering the high power mode. In certain embodiments the HeNB may be considered a low-power HeNB.

Although certain embodiments have been illustrated and described herein for purposes of description, this application is intended to cover any adaptations or variations of the embodiments discussed herein. Therefore, it is manifestly intended that embodiments described herein be limited only by the claims.

Where the disclosure recites “a” or “a first” element or the equivalent thereof, such disclosure includes one or more such elements, neither requiring nor excluding two or more such element. Further, ordinal indicators (e.g., first, second or third) for identified elements are used to distinguish between the element, and do not indicate or imply a required or limited number of such elements, nor do they indicate a particular position or order of such elements unless otherwise specifically stated.

What is claimed is:

1. A method for reducing power consumption in an enhanced NodeB (eNB) in a wireless network comprising:
transmitting, to a user equipment (UE), one or more parameters of a wake-up procedure;
entering a low power state from a high power state;
monitoring for reception of a wake-up signal based at least in part on the one or more parameters;
entering, responsive to the reception of the wake-up signal, a high power state; and
transmitting, responsive to the reception of the wake-up signal, a connection establishment signal to the UE.

2. The method of claim 1 wherein the wake-up signal is received by the eNB on a random access channel (RACH).

3. The method of claim 1 wherein the eNB is configured to continuously monitor for the wake-up signal and the wake-up signal has a length of two orthogonal frequency division multiplexing (OFDM) symbols.

4. The method of claim 1 wherein the one or more parameters of the wake-up procedure comprise a digital sequence to be used for the wake-up signal and a length of a listening interval comprising at least one listening period having a listening length and at least one non-listening period.

5. The method of claim 4 wherein the wake-up signal has a length which is at least the listening length.

6. The method of claim 4 wherein the wake-up signal has a length which is at least the length of the listening interval.

7. The method of claim 4 wherein the wake-up signal has a length which is less than the listening length.

8. The method of claim 4 wherein the one or more parameters of the wake-up procedure include timing of the listening period.

9. A user equipment (UE) comprising:
receiver circuitry configured to receive one or more parameters of a wake-up procedure;
processing circuitry configured to determine that the UE should connect to an enhanced NodeB (eNB);
transmission circuitry configured to transmit a wake-up signal to the eNB based at least in part on the one or more parameters responsive to the determination, the wake-up signal configured to cause the eNB to enter a high power state from a low power state; and
the receiver circuitry further configured to receive a transmission related to a connection establishment procedure.

10. The UE of claim 9, wherein the transmission circuitry is further configured to transmit the wake-up signal on a random access channel.

11. The UE of claim 9 wherein the one or more parameters of the wake-up procedure include a digital sequence to be used by the UE for the wake-up signal, and a length of a listening interval comprising a listening period having a listening length and further comprising a non-listening period.

12. The UE of claim 11 wherein the wake-up signal has a length which is at least the listening length.

13. The UE of claim 11 wherein the wake-up signal has a length which is at least the length of the listening interval.

14. The UE of claim 11 wherein the wake-up signal has a length which is less than the listening length.

15. The UE of claim 11 wherein the negotiated parameters of the wake-up procedure include timing of the listening period.

16. A Home enhanced NodeB (HeNB) comprising:
a transmitter configured to transmit one or more parameters of a wake-up procedure to a user equipment (UE);
a receiver configured to receive a wake-up signal based at least in part on the one or more parameters of the wake-up procedure; and
a power controller configured to enter a low power mode after the transmission of the one or more parameters of the wake-up procedure, the power controller further configured to, upon reception of the wake-up signal by the receiver, enter a high power mode from the low power mode;
wherein the transmitter is further configured to, after the HeNB enters the high power mode, transmit a connection establishment signal to the UE.

17. The HeNB of claim 16 wherein the HeNB is a low-power HeNB.

18. The HeNB of claim 16 wherein the receiver is configured to continuously monitor for the wake-up signal.

19. The HeNB of claim 16 wherein the receiver is configured to receive the wake-up signal on a random access channel.

20. The HeNB of claim 16 wherein the one or more parameters of the wake-up procedure include a digital sequence for the wake-up signal, and a length of a listening interval comprising a listening period having a listening length and a non-listening period.

21. The HeNB of claim 20 wherein the wake-up signal has a length which is at least the listening length.

22. The HeNB of claim 20 wherein the wake-up signal has a length which is at least the length of the listening interval.

23. The HeNB of claim 20 wherein the wake-up signal has a length which is less than the listening length.

24. The HeNB of claim 20 wherein the negotiated parameters of the wake-up procedure include timing of the listening period.
